(19) United States
(12) Patent Application Publication
(10) Pub. No.: US 2018/0025014 A1
(43) Pub. Date: Jan. 25, 2018

(54) Employing Biometric Data for Data Storage Management

(71) Applicant: International Business Machines Corporation, Armonk, NY (US)

(72) Inventors: Su Liu, Austin, TX (US); Eric J. Rozner, Austin, TX (US); Chin Ngai Sze, Austin, TX (US); Yaoguang Wei, Austin, TX (US)

(73) Assignee: International Business Machines Corporation, Armonk, NY (US)

(21) Appl. No.: 15/213,451

(22) Filed: Jul. 19, 2016

(51) Int. Cl. G06F 17/30; G06F 21/62

(52) U.S. Cl. CPC G06F 17/30091; G06F 21/6218; G06F 17/30153; G06F 17/30156

(57) ABSTRACT

Embodiments relate to a system, method, and computer program product to allocate an electronic file in memory based on biometric data. Biometric data is captured from a biosensor and associated with an electronic file. The biometric data is stored with file metadata for the electronic file and used to assign a biometric score to the electronic file. The assigned biometric score is then used to allocate the electronic file within memory by evaluating storage characteristics of the electronic file together with storage capacity of associated data storage. In one embodiment, a storage optimization technique for the file is selected and applied based on the evaluation.

### BACKGROUND

The present embodiments relate to data storage management. More specifically, the embodiments relate to capturing biometric data and employing the captured biometric data to improve data storage management.

The term storage management encompasses technologies and processes used to maximize or improve performance of data storage resources. It is understood that capacity of data storage devices is finite. Although the cost of commodity storage devices has been declining, management of additional storage devices remains challenging. Policies may be employed for managing the storage devices so that files are appropriately assigned or moved to a select storage device at certain times. At the same time, policies may be invoked for data backup, data recovery, and performance analysis, as well as facilitate use of tiered storage, storage pools, and thin provisioning.

Files that are frequently accessed may be assigned to a select storage device or an area of a storage device based on the access frequency. When a storage device is at or near capacity, a file optimization technique may be invoked to compress data or eliminate duplicate copies of the data. Accordingly, various techniques may be employed to mitigate redundancy of data.

### SUMMARY

A method, computer program product, and computer system are provided for employing biometric data for storage management.

In one aspect, a computer system is provided with a processing unit operatively coupled to memory, a biosensor in communication with the processing unit, and a storage manager in communication with the processing unit and memory to allocate an electronic file in memory based on biometric data. The allocation conducted by the storage manager includes receipt of biometric data from the biosensor and association of the biometric data with the electronic file. The biometric data is stored with file metadata for the electronic file, and a biometric score is assigned to the electronic file. Allocation of the electronic file in data storage takes place in accordance with the biometric score. Storage characteristics of the electronic file are evaluated together with storage capacity of associated data storage. A storage optimization technique is selected and application for the file based on the evaluation.

In another aspect, a method is provided to capture biometric data, associate the biometric data with an electronic file, and store the biometric data as file metadata for the electronic file. The biometric data is used to assign a biometric score to the electronic file, the biometric score associated with the captured biometric data. Following the assignment of the biometric score, the electronic file is allocated in data storage in accordance with the biometric score. Storage characteristics of the electronic file are evaluated together with storage capacity of associated data storage. A storage optimization technique is selected and applied to the file based on the evaluation.

In yet another aspect, a computer program product is provided with a computer readable storage device having program code embodied therewith. The program code is executable by a processing unit to capture biometric data, associate the biometric data with an electronic file, store the biometric data as file metadata for the electronic file, and assign a biometric score to the electronic file. The biometric score is associated with the captured biometric data. The processing unit allocates the electronic file in memory in accordance with the biometric score. The allocation includes evaluating storage characteristics of the electronic file together with storage capacity of associated data storage, selecting a storage optimization technique for the file based on the evaluation, and applying the selected technique to the file.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some, and not all embodiments unless otherwise explicitly indicated.

FIG. 1 depicts a block diagram illustrating a system employing one or more forms of biosensors and association of generated biosensor data with file management.

FIG. 2 depicts a block diagram illustrating components of a generated file.

FIG. 3 depicts a flow chart illustrating a process for associating biometric data with a file and storage management solutions.

FIG. 4 depicts a flow chart illustrating a process optimization of one or more files.

FIG. 5 depicts a schematic example of a system to implement the process of FIG. 3, and the system of FIG. 1

FIG. 6 depicts a block diagram illustrating a cloud computing environment.

FIG. 7 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, and method as presented in the Figures, is not intended to limit the scope as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiment as claimed herein.

Biometrics is the measurement and statistical analysis of physical and behavioral characteristics. A biosensor is an implantable, wearable, or portable sensor used to gather medical data from different parts of the human being. Measurements produced from biosensors include, but are not limited to, heart rate and rhythm, stress levels, breathing rate and rhythm, skin temperature, and body position. Technology has evolved to support wireless communication between the sensors and an associated device. More specifically, technology has evolved to support transmission of biometric data generated from a biometric sensor to remote computing devices, such as mobile telephones, tablets, personal computers, servers, etc.

In a related area, wearable health monitoring devices are employed to track fitness and activity. The devices may come in the form of a bracelet to track activities such as walking, sleeping, calorie intake, calories burning, and other metrics. The devices may tally walking pace and distance, and in one embodiment can be synced to monitor heart rate. Accordingly, fitness trackers, for example, are employed to enable the capture of biometric measurement.

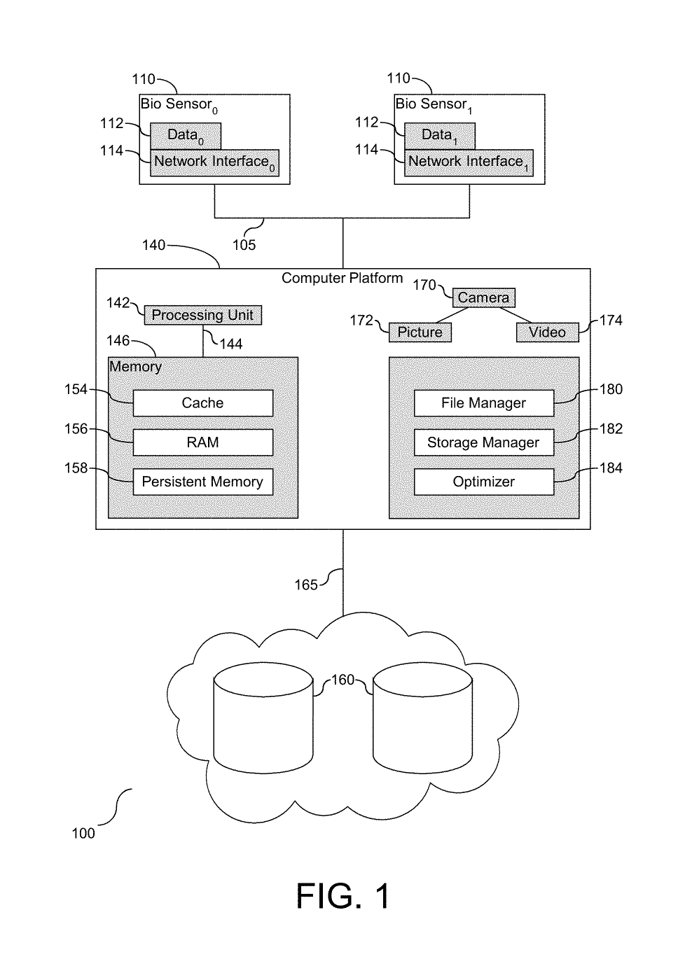

The biometric data generated from the sensors are transmitted at regular or irregular time intervals from the sensor measurement device to a paired computing device. Referring to FIG. 1, a block diagram (100) is provided of a system employing one or more forms of biosensors and association of generated biosensor data with file management. Two forms of biosensors are shown, including biosensor₀ (110) and biosensor₁ (120). In one embodiment, the system may be limited to a single biosensor, or the system may include three or more biosensors. As such, the quantity of biosensors in the system should not be considered limiting. Similarly, in a system with multiple biosensors, each sensor is configured to acquire different forms of biometric data, although in one embodiment, one or more of the forms of data may be overlapping. Each of the biosensors (110) and (120) are shown in communication with a computing platform (140). Examples of computing platforms include, but are not limited to, a mobile telecommunication device, tablet computer, laptop computer, desktop computer, server, etc. In the system shown herein, each biosensor (110) and (120) is in separate communication with the computing platform (140) across a network connection (105).

Each biosensor is configured to acquire biometric data, either on a periodic basis or on demand. Data generated by the sensor is communicated across the network (105) to the computing platform (140). As shown herein, biosensor₀ (110) generates biometric data₀ (112), and employs network interface (114) to transmit the data to the computing platform (140). Similarly, biosensor₁ (120) generates biometric data₁ (122), and employs network interface (124) to transmit the data to the computing platform (140). Each sensor may be configured with local memory to temporarily store the generated data. As shown, biosensor₀ (110) is configured with memory (116) to store data (114), which is transmitted across the network (105) to the computing platform (140), and biosensor₁ (120) is configured with memory (126) to store data (124), which is transmitted across the network (105) to the computing platform (140). The configuration of the sensors with local memory enables periodic transmission of the generated data.

The computing platform (140) is shown with a processing unit (142) in communication with memory (146) across a bus (144). In the example shown herein, memory (146) includes cache (154), random access memory (156), and persistent memory (158). In one embodiment, the memory (146) may be configured to include additional or alternate forms of transient and persistent storage. For example, in the embodiment shown, the computing platform (140) is shown in communication with a remote persistent storage device (160) across network connection (165). In the example shown herein, the persistent storage device (160) is a shared resource accessible across a network connection. The different forms of data storage may be organized in a hierarchy with each tier in the hierarchy configured to accommodate an associated workload. For example, data that is frequently accessed or data that is the most recent may be stored in cache (154). At the same time, older data or data that is infrequently accessed may be stored on persistent storage (158). Accordingly, biometric data is acquired from one or more biometric sensors, and is stored on a select tier of a multi-tier hierarchy of storage devices.

As shown herein, the computing platform (140) is configured with a camera (170) to acquire pictures and video. Each time the camera creates a file in the form of a picture (172) or video (174), the created file is stored in memory as an electronic file. At the same time, biometric data (112) and (122) from the sensors (110) and (120), respectively, coupled to the computing platform (140) is captured and logically associated with the electronic file (172) or (174). More specifically, a file manager (180) collects biometric data available from biosensors that are coupled or otherwise in communication with the platform (140) when the camera associated file is created, and logically associates the biometric data with the created file. For example, in one embodiment, the file manager (180) stores the biometric data as file metadata for the generated file. Similarly, in one embodiment, such as an enterprise storage system, the biometric data may be stored in a separate physical storage device from the created file, and logically associated with the created file. In one embodiment, the biometric data is stored in a searchable database and the file manager (180) creates a logical association between the database entry and the created file. Accordingly, the biometric data is a form of file metadata from biosensors that are in communication with the computing platform (140), and that may be stored in the file or stored in a separate location and logically associated with the created file.

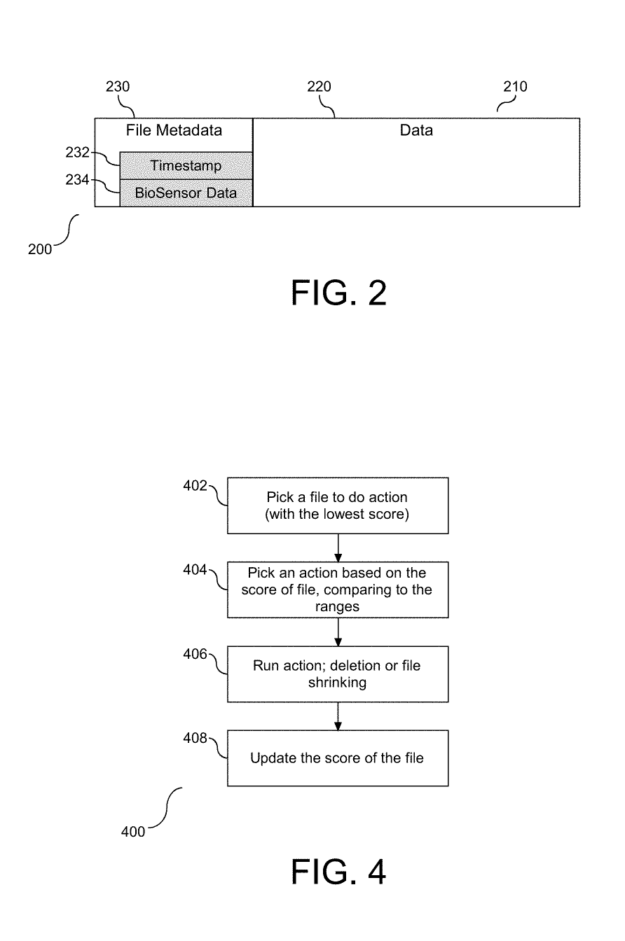

Referring to FIG. 2, a block diagram (200) is provided illustrating components of a generated file (210). In this example, the file is a video file capture from the camera (170), although other forms of files may be generated. The file (210) includes data (220) configured to store data associated with the created video. At the same time, the file (210) includes file metadata (230) which is data that summarizes or describes the file data (220). In one embodiment, the file metadata (230) generally includes data about the time the file was created (232). In one embodiment, the metadata provides context or additional information about the file. In this case, the metadata (230) is augmented with biosensor data (234). The biosensor data (234) is data captured from bio sensors that are in communication with the computing platform. Examples of biosensor data include, but are not limited to, blood pressure and heart rate. The biosensor data reflects data pertaining to the subject associated with the computing platform, and as such provides a category of metadata. In one embodiment, the camera associated with the computing platform may capture a video of an automobile accident and the associated heart rate and blood pressure from the biosensors are captured and become part of the video file metadata. As shown, the file metadata (230) is shown to include conventional file metadata, such as time at creation of the file, and biosensor data (234). Accordingly, the biometric data generated by the biometric sensors is shown herein stored with the file as part of the file metadata.

An active biometric sensor continues to acquire biometric data. As files associated with the computing platform (140) are created, the file manager (180) acquires the biometric data and either stores the biometric data as part of the file metadata or stores the biometric data on a separate storage device while logically associated the biometric data with the file. It is understood that the created file(s) may be accessed. For example, a person may select to view a video or a picture. Each time the file is accessed the file manager (180) acquires current biometric data available from the sensors and reflects the current biometric data into the association between the file and the biometric data. In one embodiment, the file data or metadata is expanded by the file manager (180) to include a timestamp each time the file was accessed or opened, and biometric sensor data at the time the file was accessed or opened. Accordingly, the biometric data associated with the file may include multiple occurrences with each occurrence associated with the file creation and file access.

The file data together with the biometric data is employed for storage management of files. As shown in FIG. 1, files may be stored in memory (146) local to the computing platform (140). There is a finite amount of storage space, and as such, the files are moved among the tiers of the storage. A file that has been recently accessed may be more likely to remain in memory (146), whereas a file less frequently accessed may be moved from memory (146) to remote persistent storage (158). At the same time, the file manager (180) may invoke a biometric assessment to manager storage of one or more of the files. The biometric assessment is a calculation directly related to accumulated file biometric data. For example, when a file is accessed, the file may create a reaction that is quantified by one of the associated biometric sensors. A positive reaction may warrant retaining the file in cache memory, whereas a negative reaction may warrant movement of the file to remote persistent storage. Examples of these reactions include a heart rate measurement, blood pressure, etc. A file access that generates a high blood pressure reading or an unhealthy heart rate measurement is a file that should be removed to remote persistent storage; and a file that yield a normal blood pressure reading or a healthy heart rate measurement should likely remain in local storage or memory. A storage manager (182) is provided in communication with the file manager (180), with the storage manager (182) responsible for assessing accumulated biometric sensor data and communicating the assessment to the file manager (180). Based on the assessment, the file manager (180) may elect to move the associated file to a different tier in the storage hierarchy. Accordingly, a biometric assessment is employed to manage a storage location of the created files.

It is understood that remote persistent storage may be comprised of commodity storage devices, which in general are less expensive than solid state device. At the same time, management of the remote persistent devices may become overwhelming, and as such, file management with the remote storage is important. An optimizer (184) is provided in communication with the file manager (180) to employ the collected biometric data for file storage management. Although the description of the optimizer (184) is described for files in the remote persistent storage, the functionality of the optimizer (184) may be employed in each of the data storage tiers. The optimizer (184) leverages the biometric sensor data to assess a biometric score for each file. In one embodiment, the biometric score may be a weighted sum of captured biometric data across milestones associated with the file. Based on the biometric score, the optimizer (184) selects a storage optimization technique to improve performance of an associated storage resource. In other words, the optimization technique accounts for both the storage resource and the biometric score in the selection process. Examples of optimization techniques may include compression, resizing, changing resolution, changing frame-rate, changing quality, de-duplication, deletion, or transfer. In one embodiment, the optimization may employ two or more of the techniques for one or more files. Similarly, in one embodiment, the optimizer executes the selected optimization technique. Accordingly, the optimizer (184) functions with the file manager (180) to leverage that biometric sensor data associated with the file.

The system described above in FIG. 1 has been labeled with tools in the form of a file manager (180), a storage manager, and an optimizer (184), hereinafter referred to as tools. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

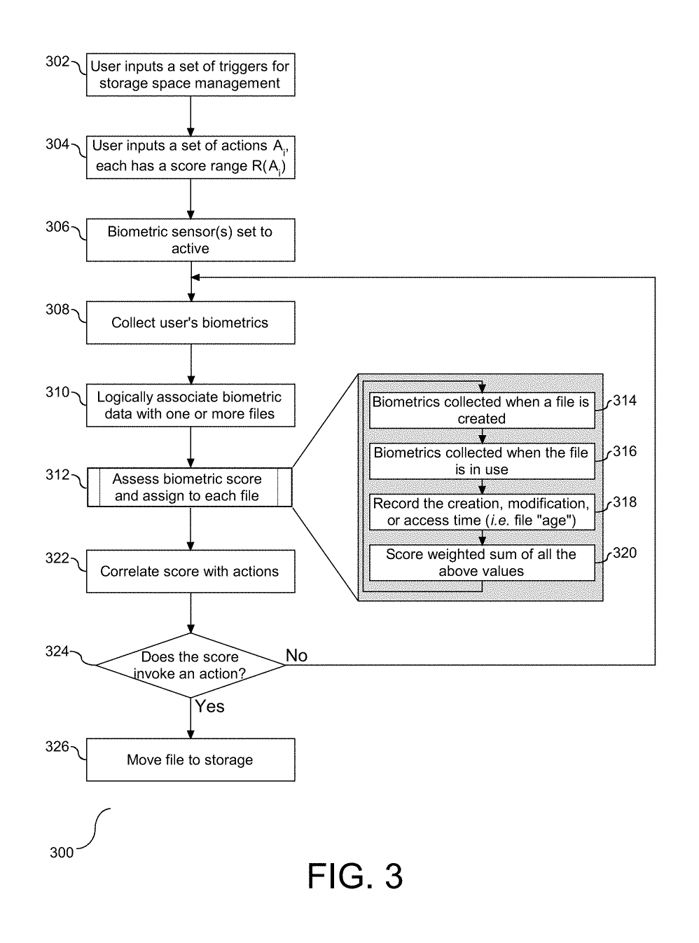

Referring now to FIG. 3, a flow chart (300) is provided illustrating a process for associating biometric data with a file and storage management solutions. As described above, a storage system may be comprised of a plurality of storage devices, with each device having different storage characteristics. In one embodiment, the storage devices may be organized in a hierarchy based on the associated device characteristics, and files may be transferred and/or subject to an optimization technique. One or more values are identified and associated with storage space management (302). In one embodiment, the identified value may include identification of insufficient storage space. Similarly, in one embodiment, the value may indicate an interval for assessing the storage space so that the data storage and associated available space is evaluated on a periodic basis. For each value or range of values identified at step (302), a set of actions, A, are identified (304). Different categories of biometric sensor data may elicit different actions. As such, at step (304) specific actions are assigned to categories of biometric sensor data and associated data values. Accordingly, the initial steps (302)-(304) relate to establishing parameters for management of files and associated biometric sensors and acquired sensor data.

Once the parameters and ranges have been established and the biometric sensors are in an active state (306), associated biometric data can be collected (308). Examples of biometric sensors include, but are not limited to, wearable devices, electronic camera, infra-red camera, mobile telecommunication device, and a mobile computing platform. Biometric data may be gathered from the biosensors during various circumstances, including a file is created or when a file is accessed. In addition, the biometric data may be gathered from the biosensor, on-demand, on a periodic basis based on a set frequency or a modifiable frequency, etc. In the example shown herein, the file is in the process of being accessed in some from and the biometric data is collected from the associated biosensors (308). The collected biometric data, e.g. the current biometric data, is logically associated with the files being accessed (310). As described in FIG. 1, the file metadata also includes biometric data that was captured and associated with the file at the time the file was created. In one embodiment, the biometric data may be stored in a database and logically associated with the file. Other embodiments of logical association between the file and the collected biometric data may be employed, and as such, the specific embodiments described herein should not be considered limiting.

Following step (310), a biometric score is assessed and assigned to each file (312). In one embodiment, the biometric score is updated or otherwise re-assessed when any file is accessed or modified. For example, the file may have a biometric score directly related to the biometric data when the file was created, and an updated biometric score related to the biometric data when the file is accessed or modified. Accordingly, the aspect of assessing a biometric score includes collected biometric data when a file is created (314) and collecting biometric data when the file is used or accessed (316). At steps (314) and (316), the age of the file is identified and associated with the biometric data. When the file is created, read, or modified, the time associated with the creation or modification is recorded (318), and a score is assessed (320). In one embodiment, the score is a weighted sum of all of the biometric scores for the file. However, other statistical assessments may be employed, and as such, the assessment at step (320) should not be limited to the weighted sum. For example, in one embodiment, the age of the file as identified at step (314) and (316) is employed in the statistical assessment. A newer or more recent file may have a higher score than an older file. Similarly, a file with a higher biometric heart beat value may be given a higher score than that of a file with a lower biometric heart beat value. All of these biometric data values are contributing factors to the statistical assessment and may affect the location, transfer, and modifications of any of the files. Accordingly, each file is re-assessed with current biometric data when the file is accessed or modified.

As shown at step (304), categories of biometric sensor data may elicit different actions. For example, in one embodiment, an assessed score for a file may dictate where the file should be stored in the storage system. Following the reassessment at step (320), the associated score is correlated with the actions (322) established at step (304), and it is determined if the score has invoked an action (324). A negative response to the determination at step (324) is followed by continued file management and collection of biometric sensor data, as shown herein by a return to step (308). However, a positive response to the determination at step (324) is followed by moving the file to a designated storage location (326). In one embodiment, the determination at step (322) may identify a preferred storage location for the file, and the assessment may entail determining if the file is currently located in the preferred storage location, and if it is not, moving the file to the preferred location. Accordingly, the biometric sensor data and periodic assessment is converted into a storage management solution by identifying and/or transferring files among the tiers of a hierarchically organized storage system.

Storage management may be expanded to extrapolate the biometric sensor assessment to a storage optimization technique. More specifically, at step (324) it may be determined that the action associated with the assessed score is directly related to managing storage space. In one embodiment, the action from step (324) may originate with the storage system based on insufficient space or a periodic re-assessment of available storage space. Instead of moving the file to a different storage tier, the action may include changing a characteristic of the file as a space savings technique. For example, in one embodiment, the re-assessed file may be located on a persistent storage device, and the action may determine that the file is infrequently accessed and as such, to save storage space the resolution of the file may be modified so that the file occupies fewer bytes that may be allocated to a file that is more frequently access. In one embodiment, alternative file actions may include, but are not limited to, deletion, compression, re-sizing, changing frame-rate, changing quality, de-duplication, or deletion. For example, in one embodiment, the file action may include converting a file to a lower resolution, thereby releasing storage space. Accordingly, storage optimization may have a direct or indirect relationship to the collected biometric sensor data.

Referring to FIG. 4, a flow chart (400) is provided illustrating a process optimization of one or more files. In relation to the process of harnessing biosensor data with file creation and management, as shown in FIG. 3, one or more files may be selected for optimization. For example, in one embodiment, the file selection process may be determined based on a file or multiple files have a weighted sum score below a defined threshold. Similarly, in one embodiment, the selection process may be limited to a single file having the lowest score. The weighted sum score is one embodiment for assigning a statistical value to the files, and in one embodiment, other forms of statistical analysis may be employed for file identification. As shown, based on the actions being employed for file identification, one or more files are selected (402), and an action for the selected file is either selected or determined (404). In one embodiment, the action is determined based on the statistical category and associated score. Similarly, in one embodiment, the score is assessed against a range for the statistical category, with the assessment dictating the action to be taken on the file. Following step (404), the action is executed on the file(s) (406), and the associated biometric assessment score is updated (408). The process of performing an optimization action on one or more files at step (404) may relate to reducing the storage footprint of the file. This may include, but is not limited to, changing the resolution of a digital file, compression of the file, shrinking, deletion, etc. Following the optimization and score re-assessment, the process then returns to step (324) in FIG. 3. Accordingly, optimization of additional files in the storage system may be warranted based on the updated biometric assessment score.

As shown in FIGS. 3 and 4, a statistical analysis of the biometric sensor data produces a biometric score which is converted to storage management. Different action may be invoked for the storage management, including transfer of files among a storage hierarchy, and optimization of one or more files within the storage system to make storage space available for additional files.

It is understood that the processes shown and described in FIGS. 3 and 4 may be executed on a local computing platform, such as a tablet or smartphone. Similarly, it is understood that the process may be executed on a shared resource, such as a cloud based resource. For example, a camera on a smartphone may function to create a picture or video file, and a wrist band may be configured with a sensor to gather biometric data in the form of movement data, and both the file and the biometric data may be stored on a shared data storage device, e.g. a cloud based storage device. Similarly, the file and storage managers and the optimizer together with their functionality may be embedded on a shared resource and accessible via a network connection to the shared resource.

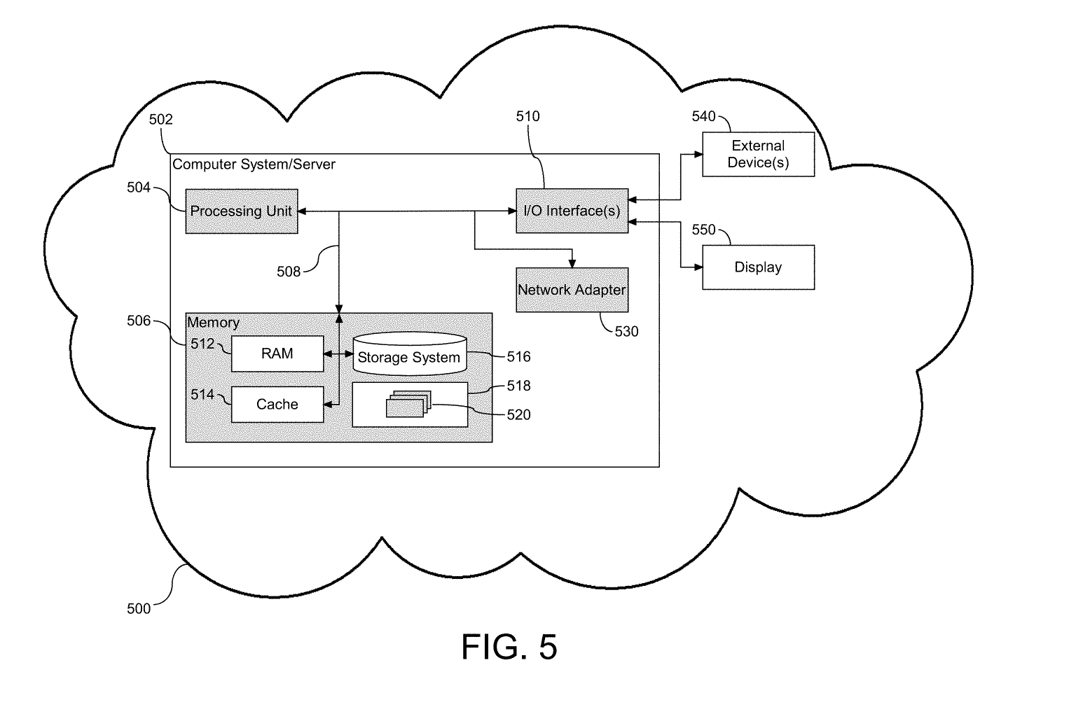

With reference to FIG. 5, a block diagram (500) is provided illustrating an example of a computer system/server (502), hereinafter referred to as a host (502) of a cloud based support system, to implement the processes described above with respect to FIG. 3. Host (502) is operational with numerous other general purpose or special purpose computing system environments or configurations. Examples of well-known computing systems, environments, and/or configurations that may be suitable for use with host (502) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems or devices, and the like.

Host (502) may be described in the general context of computer system-executable instructions, such as program modules, being executed by a computer system. Generally, program modules may include routines, programs, objects, components, logic, data structures, and so on that perform particular tasks or implement particular abstract data types. Host (502) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, host (502) is shown in the form of a general-purpose computing device. The components of host (502) may include, but are not limited to, one or more processors or processing units (504), a system memory (506), and a bus (508) that couples various system components including system memory (506) to processor (504). Bus (508) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (502) typically includes a variety of computer system readable media. Such media may be any available media that is accessible by host (502) and it includes both volatile and non-volatile media, removable and non-removable media.

Memory (506) can include computer system readable media in the form of volatile memory, such as random access memory (RAM) (512) and/or cache memory (514). Host (502) further includes other removable/non-removable, volatile/non-volatile computer system storage media. By way of example only, storage system (516) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (508) by one or more data media interfaces.

Program/utility (518), having a set (at least one) of program modules (520), may be stored in memory (506) by way of example, and not limitation, as well as an operating system, one or more application programs, other program modules, and program data. Each of the operating systems, one or more application programs, other program modules, and program data or some combination thereof, may include an implementation of a networking environment. Program modules (520) generally carry out the functions and/or methodologies of embodiments of employing and correlating biometric data with data storage management as described herein. For example, the set of program modules (520) may include the modules configured to implement the data storage management process(es) described above with reference to FIG. 3.

Host (502) may also communicate with one or more external devices (540), such as a keyboard, a pointing device, etc.; a display (550); one or more devices that enable a user to interact with host (502); and/or any devices (e.g., network card, modem, etc.) that enable host (502) to communicate with one or more other computing devices. Such communication can occur via Input/Output (I/O) interface(s) (510). Still yet, host (502) can communicate with one or more networks such as a local area network (LAN), a general wide area network (WAN), and/or a public network (e.g., the Internet) via network adapter (530). As depicted, network adapter (530) communicates with the other components of host (502) via bus (508). In one embodiment, a plurality of nodes of a distributed file system (560) is in communication with the host (502) via the I/O interface (510) or via the network adapter (530). It should be understood that, although not shown, other hardware and/or software components could be used in conjunction with host (502). Examples include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (506), including RAM (512), cache (514), and storage system (516), such as a removable storage drive and a hard disk installed in a hard disk drive.

Computer programs (also called computer control logic) are stored in memory (506). Computer programs may also be received via a communication interface, such as network adapter (530). Such computer programs, when run, enable the computer system to perform the features of the present embodiments as discussed herein. In particular, the computer programs, when run, enable the processing unit (504) to perform the features of the computer system. Accordingly, such computer programs represent controllers of the computer system.

The present embodiments may be a system, a method, and/or a computer program product. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

In one embodiment, host (502) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Examples of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

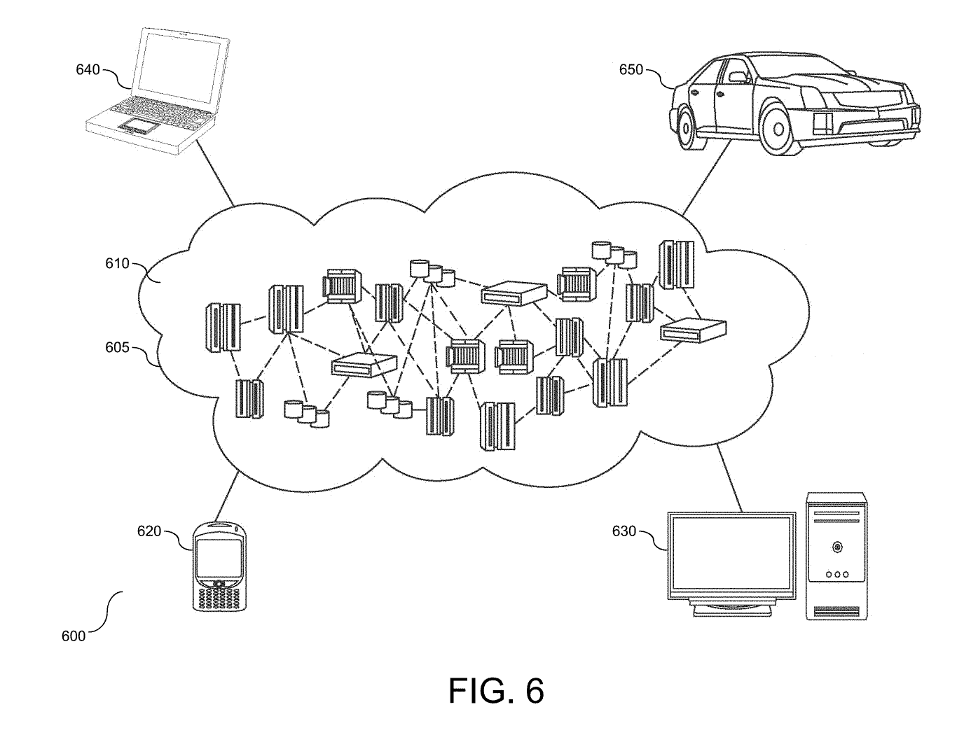

Referring now to FIG. 6, an illustrative cloud computing network (600). As shown, cloud computing network (600) includes a cloud computing environment (605) having one or more cloud computing nodes (610) with which local computing devices used by cloud consumers may communicate. Examples of these local computing devices include, but are not limited to, personal digital assistant (PDA) or cellular telephone (620), desktop computer (630), laptop computer (640), and/or automobile computer system (650). Individual nodes within nodes (610) may further communicate with one another. They may be grouped (not shown) physically or virtually, in one or more networks, such as Private, Community, Public, or Hybrid clouds as described hereinabove, or a combination thereof. This allows cloud computing environment (600) to offer infrastructure, platforms and/or software as services for which a cloud consumer does not need to maintain resources on a local computing device. It is understood that the types of computing devices (620)-(650) shown in FIG. 6 are intended to be illustrative only and that the cloud computing environment (605) can communicate with any type of computerized device over any type of network and/or network addressable connection (e.g., using a web browser).

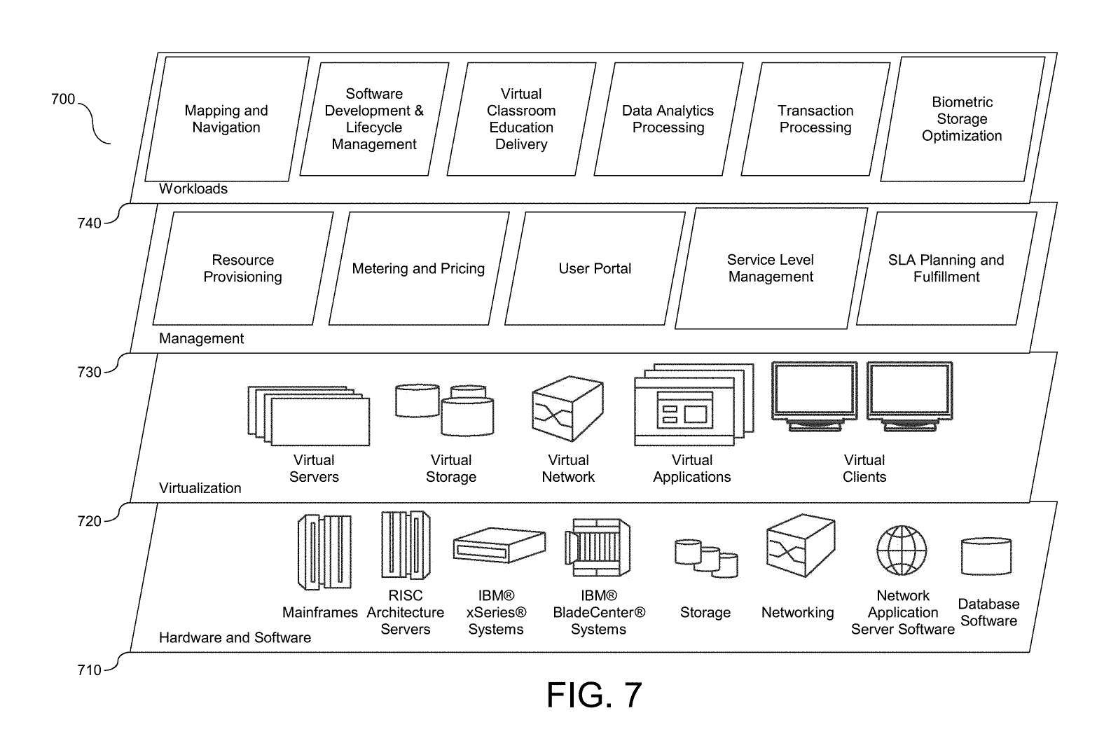

Referring now to FIG. 7, a set of functional abstraction layers provided by the cloud computing network of FIG. 6 is shown. It should be understood in advance that the components, layers, and functions shown in FIG. 7 are intended to be illustrative only, and the embodiments are not limited thereto. As depicted, the following layers and corresponding functions are provided: hardware and software layer (710), virtualization layer (720), management layer (730), and workload layer (740). The hardware and software layer (710) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (720) provides an abstraction layer from which the following examples of virtual entities may be provided: virtual servers; virtual storage; virtual networks, including virtual private networks; virtual applications and operating systems; and virtual clients.

In one example, management layer (730) may provide the following functions: resource provisioning, metering and pricing, user portal, service level management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (740) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and biometric assessment in support of storage optimization within the cloud computing environment.

As will be appreciated by one skilled in the art, the aspects may be embodied as a system, method, or computer program product. Accordingly, the aspects may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the aspects described herein may take the form of a computer program product embodied in one or more computer readable medium(s) having computer readable program code embodied thereon.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The embodiments are described above with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow chart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flow chart and/or block diagram block or blocks.

The flow charts and block diagrams in the Figures illustrate the architecture, functionality, and operation of possible implementations of systems, methods, and computer program products according to various embodiments. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustration(s), and combinations of blocks in the block diagrams and/or flow chart illustration(s), can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. It is understood that the embodiments were chosen and described in order to best explain the principles and the practical application, and to enable others of ordinary skill in the art to understand the embodiments with various modifications as are suited to the particular use contemplated. Accordingly, the biometric sensor data is employed to manage efficient and effective storage of files.

It will be appreciated that, although specific embodiments have been described herein for purposes of illustration, various modifications may be made without departing from the spirit and scope. Accordingly, the scope of protection of the embodiments is limited only by the following claims and their equivalents.

We claim:

1. A computer system comprising:
a processing unit operatively coupled to memory;
a biosensor in communication with the processing unit, the biosensor to gather biometric data;
a storage manager in communication with the processing unit and memory to allocate an electronic file in memory based on the gathered biometric data, including:
receipt of biometric data from the biosensor;
association of the biometric data with the electronic file and storage of the biometric data with file metadata for the electronic file;
assignment of a biometric score to the electronic file, the biometric score associated with the captured biometric data;
allocation of the electronic file in data storage in accordance with the biometric score;
evaluation of storage characteristics of the electronic file together with storage capacity of associated data storage;
selection of a storage optimization technique for the file based on the evaluation; and
application of the selected technique to the file.

2. The computer system of claim 1, wherein the biometric data is received by the storage manager together with a file event selected from the group consisting of: file creation, reading the file, and accessing the file.

3. The computer system of claim 2, wherein assignment of a biometric score to the electronic file further comprises the storage manager to calculate a weighted sum of the captured biometric data across a plurality of milestones associated with the electronic file.

4. The computer system of claim 3, further comprising the storage manager to assess the biometric score, and select the storage optimization technique based on the assessment.

5. The computer system of claim 4, wherein the storage optimization technique is selected from the group consisting of: compression, re-sizing, changing resolution, changing frame rate, changing quality, de-duplication, deletion, and transfer.

6. A method comprising:
capturing biometric data;
associating the biometric data with an electronic file and storing the biometric data as file metadata for the electronic file;
assigning a biometric score to the electronic file, the biometric score associated with the captured biometric data; and
allocating the electronic file in data storage in accordance with the biometric score;
evaluating storage characteristics of the electronic file together with storage capacity of associated data storage;
selecting a storage optimization technique for the file based on the evaluation; and
applying the selected technique to the file.

7. The method of claim 6, wherein the captured biometric data is acquired with a file event selected from the group consisting of: file creation, reading the file, and accessing the file.

8. The method of claim 7, wherein assigning a biometric score to the electronic file further comprises calculating a weighted sum of the captured biometric data across a plurality of milestones associated with the electronic file.

9. The method of claim 8, further comprising assessing the biometric score, and selecting the storage optimization technique based on the assessment.

10. The method of claim 9, wherein the storage optimization technique is selected from the group consisting of: compression, re-sizing, changing resolution, changing frame rate, changing quality, de-duplication, deletion, and transfer.

11. A computer program product for data storage management, the computer program product comprising a computer readable storage device having program code embodied therewith, the program code executable by a processing unit to:
capture biometric data;
associate the biometric data with an electronic file and store the biometric data as file metadata for the electronic file;
assign a biometric score to the electronic file, the biometric score associated with the captured biometric data; and
allocate the electronic file in data storage in accordance with the biometric score;
evaluate storage characteristics of the electronic file together with storage capacity of associated data storage;
select a storage optimization technique for the file based on the evaluation; and
apply the selected technique to the file.

12. The computer program product of claim 11, wherein the captured biometric data is acquired with a file event selected from the group consisting of: file creation, reading the file, and accessing the file.

13. The computer program product of claim 12, wherein assignment of a biometric score to the electronic file further comprises the processing unit to calculate a weighted sum of the captured biometric data across a plurality of milestones associated with the electronic file.

14. The computer program product of claim 13, further comprising the processing unit to assess the biometric score, and select the storage optimization technique based on the assessment.

15. The computer program product of claim 14, wherein the storage optimization technique is selected from the group consisting of: compression, re-sizing, changing resolution, changing frame rate, changing quality, de-duplication, deletion, and transfer.
